(19) United States
(12) Patent Application Publication
(10) Pub. No.: US 2024/0319981 A1
(43) Pub. Date: Sep. 26, 2024

(54) FIRMWARE UPGRADE OF IMAGE FORMING DEVICE

(71) Applicant: Hewlett-packard Development Company, L.P., Spring, TX (US)

(72) Inventors: Junghun Kim, Seongnam Si (KR); Giwon Seo, Seongnam Si (KR); Minyoung Son, Pangyo (KR); Sangmi Kim, Seongnam Si (KR); Byeongju Hwang, Seongnam Si (KR)

(21) Appl. No.: 18/576,250

(22) PCT Filed: Dec. 27, 2021
(86) PCT No.: PCT/US2021/065214

§ 371 Date: Jan. 3, 2024

(30) Foreign Application Priority Data
Jul. 5, 2021 (KR) 10-2021-0087948

(51) Int. Cl. G06F 8/65; G06F 8/71; G06F 11/07

(52) U.S. Cl. CPC G06F 8/65; G06F 8/71; G06F 11/0778

(57) ABSTRACT

An example remote management server includes a processor and a memory. The processor is to receive an error log for a plurality of applications installed in an image forming device or characteristics of the image forming device, update a stability table indicating compatibility between respective versions of the plurality of applications and a platform version associated with each of a plurality of firmware that is installable in the image forming device based on the received error log, and identify a firmware that is to be installed in the image forming device without any incompatibility based on the updated stability table.

### BACKGROUND

As types of image forming devices, there are individual devices such as printers, scanners, photocopiers, fax machines, and the like, and there are also multi-function printers (MFPs) in which functions of these individual devices are integrated into one device. Firmware for controlling such an image forming device may be upgraded through a server.

### BRIEF DESCRIPTION OF THE DRAWINGS

Various examples will be described below by referring to the following figures.

FIG. 1 is a schematic diagram illustrating a system including a server, a cloud platform, and a plurality of image forming devices according to an example.

FIG. 2 is a flowchart illustrating a method of upgrading firmware of an image forming device according to an example.

FIG. 3 is a schematic diagram for describing an operation based on firmware of an image forming device being upgraded according to an example.

FIG. 4 illustrates a stability table according to an example.

FIG. 5 illustrates a pop-up window to be displayed on a user interface of an image forming device after the image forming device requests a firmware upgrade according to an example.

FIG. 6 is a flowchart illustrating a method of upgrading firmware of an image forming device according to an example.

FIG. 7 is a schematic diagram for describing an operation based on firmware of an image forming device being upgraded according to an example.

FIG. 8 is a flowchart illustrating a method of upgrading firmware of an image forming device according to an example.

FIG. 9 is a schematic diagram for describing an operation based on firmware of an image forming device being upgraded according to an example.

FIG. 10 is a diagram for describing a method of updating a stability table according to an example.

FIG. 11 illustrates a stability table according to an example.

FIG. 12 is a diagram illustrating a system including a server, a cloud platform, and a plurality of image forming devices according to an example.

FIG. 13 is a schematic diagram for describing an operation based on firmware of an image forming device being upgraded according to an example.

FIG. 14 illustrates a stability table according to an example.

FIG. 15 is a diagram illustrating instructions stored in a non-transitory computer-readable recording medium according to an example.

### DETAILED DESCRIPTION

In a case in which firmware for controlling an image forming device is upgraded through a server, there may be an incompatibility between firmware to be installed and an application installed in the image forming device. In that case, the image forming device may cause a malfunction or an error may occur. As an example, the server may perform the upgrade using the latest version of firmware in the image forming device. However, some applications in the image forming device may not be compatible with the latest version of firmware and thus may not be able to operate normally. In this case, there may be an inconvenience such as having to downgrade the firmware in the image forming device or having to upgrade an incompatible application in person or remotely by an administrator on the service provider's side.

Examples are described that provide a technique in which, based on firmware being upgraded in an image forming device by a server, a version of firmware is installed that is compatible with an application previously installed in the image forming device. In that case, the image forming device can be stably used even after the firmware is upgraded.

Although terms used herein are selected from among general terms that are currently and widely used in consideration of functions of the described examples, these may be changed according to precedents or the advent of new technology. In addition, some terms may be arbitrary selected. In this case, meanings thereof may be discerned based on a corresponding description of examples. Therefore, the terms used herein should be defined based on meanings of the terms and content of this entire specification, rather than simply the terms themselves.

Throughout this specification, in a situation in which a certain part is described to “include” a certain component, it means that another component may be further included rather than excluding the other component unless otherwise defined.

It will be understood that, although the terms “first,” “second,” etc. may be used herein to describe various elements, these elements should not be limited by these terms. These terms are used to distinguish one element from another. For example, a first element could be termed a second element, and, similarly, a second element could be termed a first element, without departing from the scope of the described examples. As used herein, the term “and/or” includes any and all combinations of the associated listed items.

Throughout this specification, the term “image forming device” refers to any device capable of performing an image forming operation, such as a copier, a printer, a scanner, a fax machine, a multi-function printer (MFP), a display device, or the like. Further, the image forming device may be a two-dimensional (2D) image forming device or a three-dimensional (3D) image forming device. Such an image forming device may provide a basic function such as copying, printing, scanning, and faxing, as well as various additional functions.

The term “firmware” may correspond to a program for controlling an operation of an image forming device and the term “platform” may correspond to a program for controlling an operation of an application installed in the image forming device. The firmware and the platform correspond to separate programs and, for example, even based on two firmware versions being different, platform versions associated with the two firmware versions may not be different.

Hereinafter, examples will be described with reference to the accompanying drawings. However, the examples may be implemented in several different forms and are not limited to those described herein.

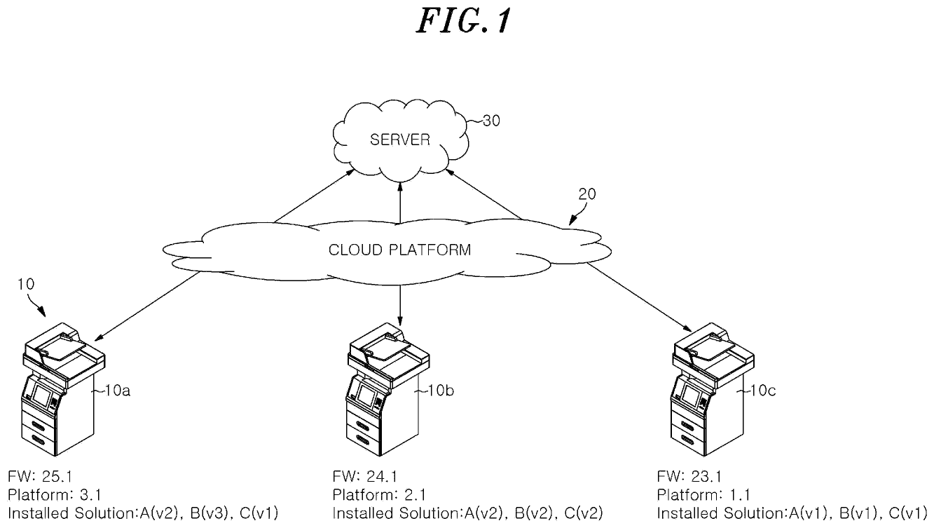

FIG. 1 is a schematic diagram illustrating a system including a server, a cloud platform, and a plurality of image forming devices according to an example.

Referring to FIG. 1, a system includes a server 30, a cloud platform 20, and a plurality of image forming devices 10 (i.e., 10a, 10b, and 10c). In the example of FIG. 1, although the server 30 and the cloud platform 20 are illustrated as being separated, the server 30 and the cloud platform 20 are functionally separated and may be implemented by being integrated into one component or may be implemented in the form of being distributed over several entities. In the following description, the server 30 and the cloud platform 20 together will be referred to as a “remote management server.”

The image forming device 10 may include a plurality of image forming devices 10a, 10b, and 10c and, in each of the image forming devices 10a, 10b, and 10c, firmware, a platform associated with the firmware, and an application may be installed.

Here, the “firmware” may correspond to a program for controlling an operation of the image forming device, and the “platform” may correspond to a program for controlling an operation of an application installed in the image forming device. For convenience of description, as shown in Table 1 below, each firmware version may have an Android operating system (OS) version, an Android application programming interface (API) version, an application (App) API version, and an application platform version corresponding thereto. Here, a program that controls the operation of the application installed in the image forming device 10 is an application platform. Therefore, the firmware and the (application) platform are associated with each other but may correspond to separate programs. In an example, in a situation in which two firmware versions are different, platform versions associated with the two firmware versions may not be different. For example, in the case of Firmware Versions 4.10 and 4.11, although the firmware versions are different, platform versions may be the same (e.g., App Platform Version 26.4).

TABLE 1

| Firmware | Android OS | Android API | App API | App Platform |
|---|---|---|---|---|
| Version | Version | Version | Version | Version |
| 4.6.2.1 | Kitkat | 19 | Beta | Beta |
| 4.7 | Kitkat | 19 | Beta | Beta |
| 4.8.0.1 | Kitkat | 19 | 3 | 19.3 |
| 4.9.0.1 | Kitkat | 19 | 4 | 19.4 |
| 4.10 | Oreo | 26 | 4 | 26.4 |
| 4.11 | | | | |
| 5.1 | Android 10 | 29 | 4 | 29.4 |

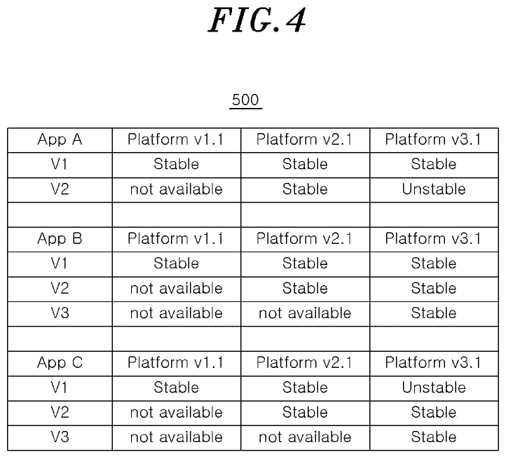

The cloud platform 20 may connect the server 30 and the image forming devices 10a, 10b, and 10c and support performance of a remote operation on one of the image forming devices 10a. 10b, or 10c through the server 30. The cloud platform 20 may maintain information about a version of firmware and a version of an application which is currently installed in the image forming devices 10a, 10b, and 10c. Further, the cloud platform 20 may maintain stability information, for example, a stability table, indicating compatibility between the respective versions of the platform associated with firmware installable in the image forming devices 10a, 10b, and 10c and the version of the application installed in the image forming devices 10a, 10b, and 10c (e.g., as shown in FIG. 4). An example of a stability table will be described in more detail below. A part or all of the information of the stability table may be separately maintained in a file transfer protocol (FTP) server, and the cloud platform 20 may be implemented to query and receive the information and the stability table maintained in the FTP server. However, examples are not limited thereto.

The server 30 may be communicatively connected to the cloud platform 20 and the plurality of image forming devices 10a, 10b, and 10c via a network. The server 30 may install the application or upgrade the firmware in the image forming devices 10a, 10b, and 10c located remotely.

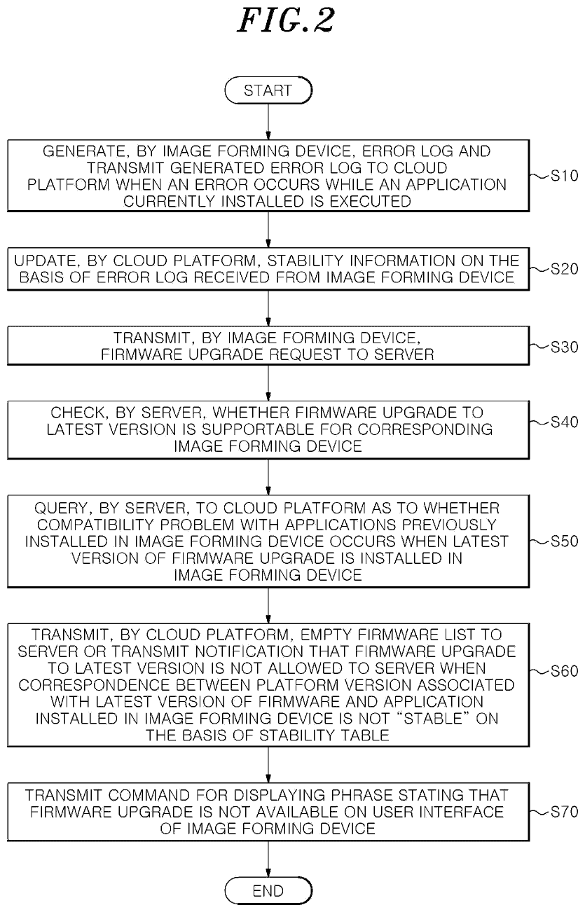

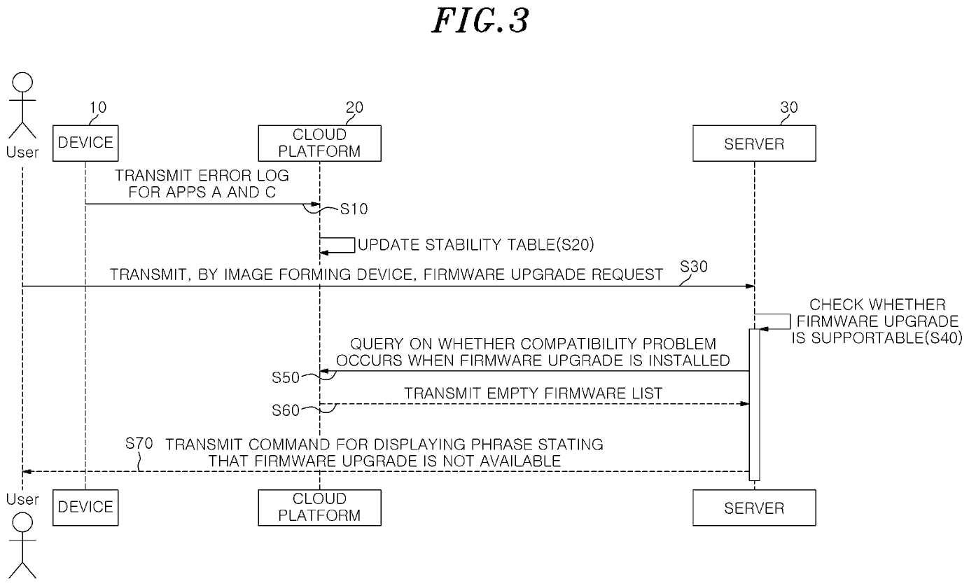

FIG. 2 is a flowchart illustrating a method of upgrading firmware of an image forming device according to an example, and FIG. 3 is a schematic diagram for describing an operation based on firmware of an image forming device being upgraded according to an example. Hereinafter, an example of upgrading firmware of an image forming device will be described with reference to FIGS. 2 and 3.

Referring to FIGS. 2 and 3, based on an error occurring on a platform of firmware currently installed while an application currently installed is executed, the image forming device 10 may generate an error log for the error and transmit the generated error log to the cloud platform 20 in operation S10.

As an example, as illustrated in FIG. 1, in a first image forming device 10a, firmware version 25.1, platform version 3.1, version v2 of application A, version v3 of application B, and version v1 of application C may be installed. Further, in a second image forming device 10b, firmware version 24.1, platform version 2.1, version v2 of application A, version v2 of application B, and version v2 of application C may be installed. Further, in a third image forming device 10c, firmware version 23.1, platform version 1.1, version v1 of application A, version v1 of application B, and version v1 of application C may be installed.

A version of an application installed in an image forming device 10a, 10b, or 10c may not be compatible with a platform version, and thus a malfunction or an error may occur in the corresponding image forming device 10a, 10b, and 10c. For example, based on the version v2 of application A and the version v1 of application C installed in the first image forming device 10a being operated on the platform version 3.1, an error may occur. In various examples, the error may occur intermittently, frequently, continuously, etc. In the case of an error occurring, the first image forming device 10a may generate an error log including information about the error (i.e., information regarding an error that occurs for the version v2 of application A and the version v1 of application C) and transmit the generated error log to the cloud platform 20. In various examples, the error log may be transmitted periodically, transmitted immediately based on occurrence of the error, etc.

The cloud platform 20 may update stability information such as a stability table on the basis of the error log received from the image forming device 10 in operation S20.

FIG. 4 illustrates a stability table according to an example.

Referring to FIG. 4, based on a version of an application operating stably on a version of a platform (e.g., operating without any error), a correspondence between the version of the application and the version of the platform may be marked as “Stable” in a stability table 500. Further, based on the version of the application not being able to be executed on the version of the platform, the correspondence between the version of the application and the version of the platform may be marked as “Not Available” in the stability table 500. Further, based on the version of the application causing an error intermittently or frequently on the version of the platform, the correspondence between the version of the application and the version of the platform may be marked as “Unstable” in the stability table 500.

In this case, for example, based on it being newly confirmed from the error log received from the first image forming device 10a that an error occurs in the case in which the version v2 of application A currently installed in the first image forming device 10a is operated on the platform version 3.1, the cloud platform 20 may update to change a correspondence between the version v2 of application A and the platform version 3.1 to “Unstable” in the stability table 500. Further, the information about the version of the firmware and the versions of the applications and the stability table may be updated in response to an event such as adding, deleting, or upgrading the application installed in the corresponding image forming device, upgrading or downgrading the firmware, or the like.

The image forming device 10 may transmit a firmware upgrade request to the server 30 in operation S30.

Based on the server 30 receiving the firmware upgrade request from the image forming device 10, the server 30 may check whether a firmware upgrade to the latest version is supportable for the corresponding image forming device 10 in operation s40.

Based on confirmation that the firmware upgrade to the latest version is supportable for the image forming device 10 in the server 30, the server 30 may query the cloud platform 20 as to whether incompatibility with the applications previously installed in the image forming device 10 occurs based on the latest version of the firmware upgrade being installed in the image forming device 10 in operation S50.

In response thereto, the cloud platform 20 identifies firmware(s) that can be installed without any incompatibility between the application and the platform of the image forming device 10 in view of information about the compatibility of the platform version and the application version which are included in the stability table 500. And, as a result of the identification, the cloud platform 20 detects whether the correspondence between the platform version (e.g., platform version 3.1) associated with the latest version of firmware (e.g., firmware version 25.1) and the application installed in the image forming device 10 is “Stable.” In an example, based on detecting that the correspondence between the platform version associated with the latest version of the firmware and the application installed in the image forming device 10 is not “Stable,” that is, based on detecting that there is an application that does not operate stably with the latest version of firmware, the cloud platform 20 may transmit an empty firmware list to the server 30 or transmit a notification that the firmware upgrade to the latest version is not allowed to the server 30 in operation S60.

For example, referring again to FIG. 1, in the second image forming device 10b, the firmware version 24.1, the platform version 2.1, the version v2 of application A, the version v2 of application B, and the version v2 of application C may be currently installed. According to the stability table of FIG. 4, it may be detected that based on performing a firmware upgrade to a version 25.1, which is the latest version, the version v2 of application A corresponding to platform version 3.1 associated with the latest version 25. 1 of firmware is marked as “Unstable,” and thus the cloud platform 20 may detect that it is inappropriate to upgrade from the firmware version 24.1 to the firmware version 25.1.

Based on detecting that there is no “Stable” platform version that does not cause any incompatibility with the application, and thus receiving by the server 30 an empty firmware list or a notification that the firmware upgrade to the latest version is not allowed from the cloud platform 20, the server 30 may transmit a command for displaying on a user interface of the image forming device 10 that the firmware upgrade is not available in operation S70.

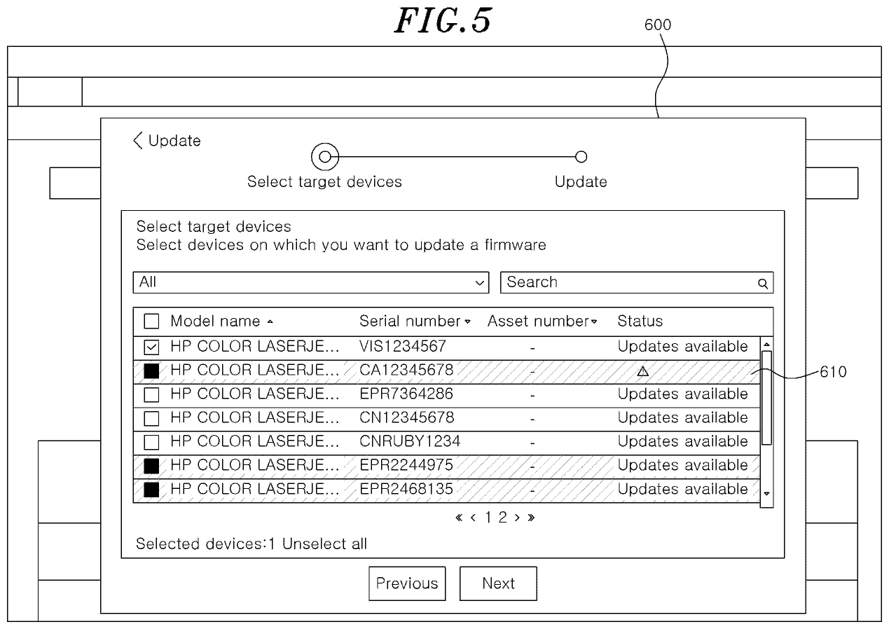

FIG. 5 illustrates a pop-up window to be displayed on a user interface of an image forming device after the image forming device requests a firmware upgrade according to an example.

Referring to FIG. 5, a pop-up window 600 may be displayed on the user interface of the image forming device 10 after the image forming device 10 requests the firmware upgrade. According to an example, based on a command for displaying on the user interface of the image forming device 10 that there is no upgradable firmware being received from the server 30, the requested firmware upgrade may be displayed to be inactivated (e.g., hatched, grayed out, etc.) on the pop-up window 600 of the user interface of the image forming device 10 as illustrated by reference numeral 610 of FIG. 5. Accordingly, the user of the image forming device 10 may intuitively recognize that the firmware upgrade requested by the user is not allowed or there is an incompatibility with the application. Further, a phrase “upgrade not possible,” or a warning triangle indicating that the upgrade is not possible may be displayed in a status item of the pop-up window. Otherwise, a guide message may be displayed which indicates that although currently the firmware upgrade to the latest version is not possible because there is no platform version that does not cause incompatibility with the application, if the application that is not compatible with the platform version of the latest version of firmware is deleted or inactivated, the corresponding firmware may be installed. Content displayed on the user interface of the image forming device in relation to the firmware upgrade is not limited.

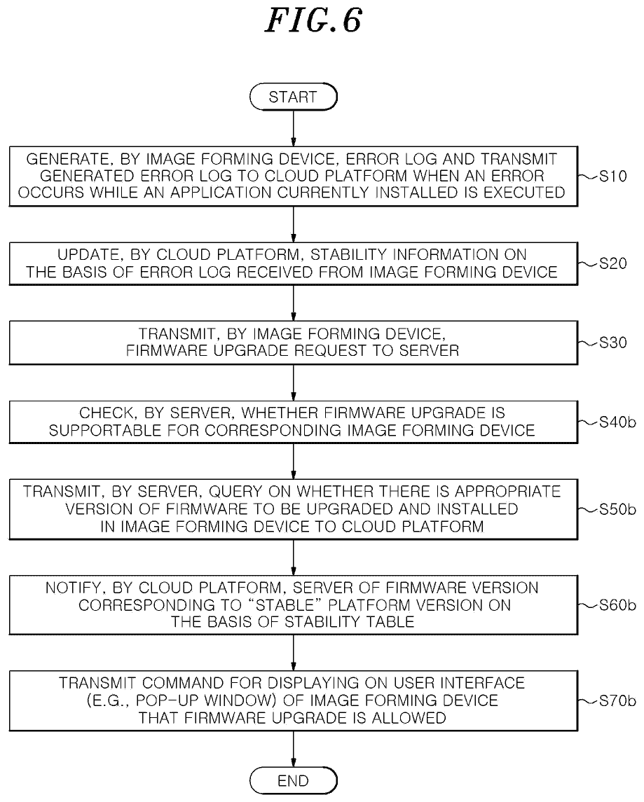

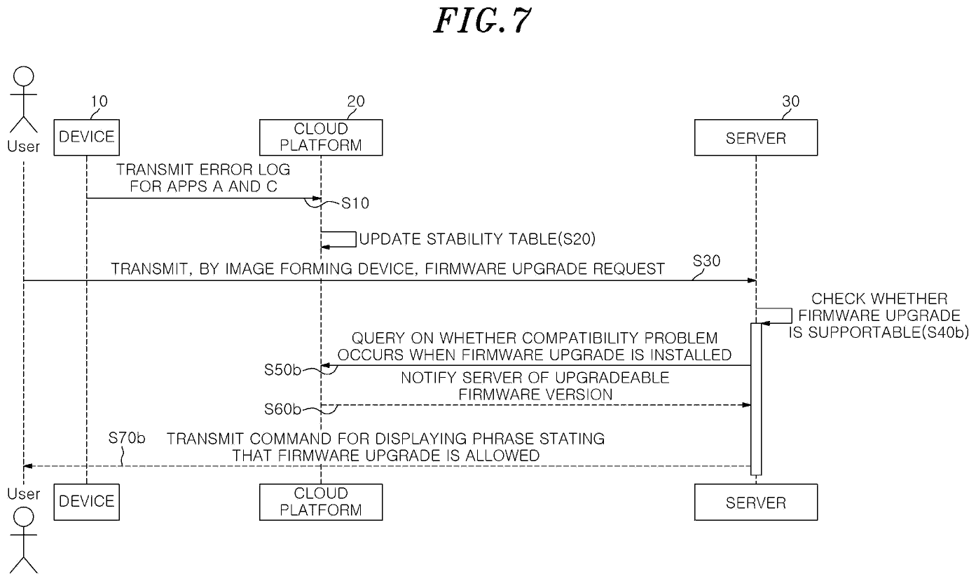

FIG. 6 is a flowchart illustrating a method of upgrading firmware of an image forming device according to an example, and FIG. 7 is a schematic diagram for describing an operation based on firmware of an image forming device being upgraded according to an example. In the example illustrated in FIGS. 6 and 7, operations S10 to S30 are the same as those described above with reference to FIGS. 2 and 3, and thus descriptions thereof will not be repeated.

The example described with reference to FIGS. 6 and 7 relates to performing an upgrade to a newest version among “Stable” firmware versions on the image forming device.

Referring to FIGS. 6 and 7, based on the server 30 receiving a firmware upgrade request from the image forming device 10 in operation S30, the server 30 may check whether a firmware upgrade is supportable for the corresponding image forming device 10 in operation S40b.

Based on it being confirmed that the firmware upgrade is supportable for the image forming device 10 in the server 30, the server 30 may transmit a query on whether there is an appropriate version of firmware to be upgraded and installed in the image forming device 10 to the cloud platform 20 in operation S50b.

In response to the query, the cloud platform 20 identifies a list of firmware versions associated with a platform version having no incompatibility and the correspondence with the application installed in the image forming device is “Stable” in view of the information about the compatibility of the platform version and the application version which are included in the stability table 500. Based on it being detected that such a firmware version(s) exists, the cloud platform 20 notifies the server 30 of a list of firmware versions corresponding to the “Stable” platform version(s) in operation S60b. The list of firmware versions may include information about firmware that is currently installable in the image forming device and information about firmware that is not installable.

For example, referring again to FIG. 1, in the image forming device 10c, the firmware version 23.1, the platform version 1.1, the version v1 of application A, the version v1 of application B, and the version v1 of application C are currently installed. However, based on the firmware being upgraded to version 25.1 (platform version 3.1), which is the latest version, the version v1 of application C may cause an error or a malfunction on the platform version 3.1 (i.e., in the stability table of FIG. 4, a compatibility relationship between the platform version 3.1 and the version v1 of application C is “Unstable”), and thus it is inappropriate to upgrade to the firmware version 25.1. However, in the firmware version 24.1 (platform version 2.1), which is the lower version, all of the applications A, B, and C installed in the image forming device 10c may be stably operable (i.e., in the stability table of FIG. 4, compatibility relationships between the platform version 2.1 and the version v1 of application A, the version v1 of application B, and the version v1 of application C are all “Stable”), and thus it is appropriate to upgrade to the firmware version 24.1. Therefore, the cloud platform 20 may notify the server 30 of the firmware version 24.1, which is the lower version, instead of the firmware version 25.1 of the latest version, as an upgradeable version.

In an example, based on the server 30 receiving a list of “Stable” firmware versions identified as not having an incompatibility with the application from the cloud platform 20, the server 30 may transmit a command for displaying on the user interface (e.g., the pop-up window) of the image forming device 10 that the firmware upgrade is allowed in operation S70b. In this case, a simple phrase stating that a firmware upgrade is allowed may be displayed, a phrase stating that an upgrade to the corresponding firmware version is allowed may be displayed showing a version of firmware, or installable firmware and non-installable firmware in the list of the firmware may be sorted and displayed, but examples are not limited thereto.

Based on the user selecting to proceed with the firmware upgrade, the upgrade to the newest version among the “Stable” firmware versions or the upgrade to the firmware version selected by the user is performed by the server 30.

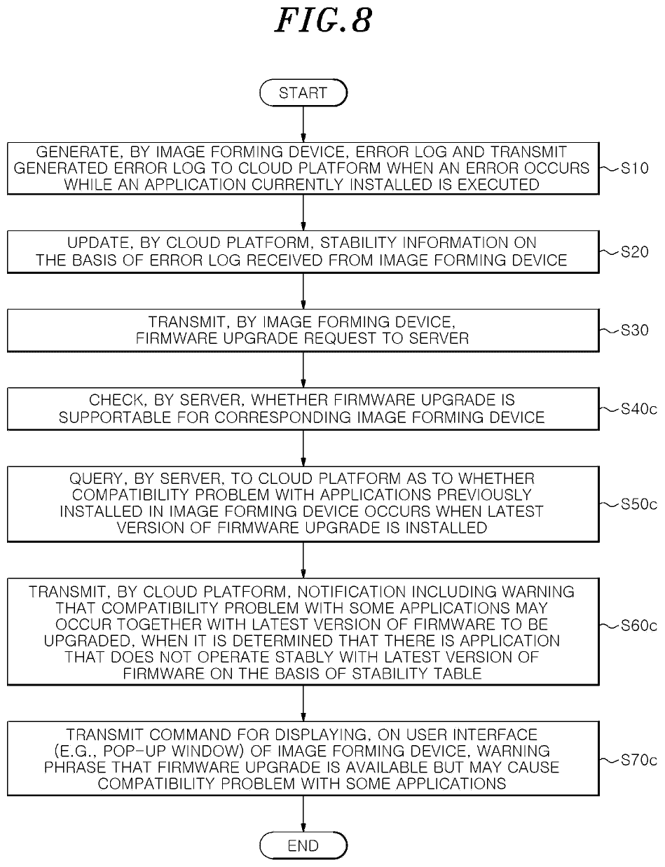

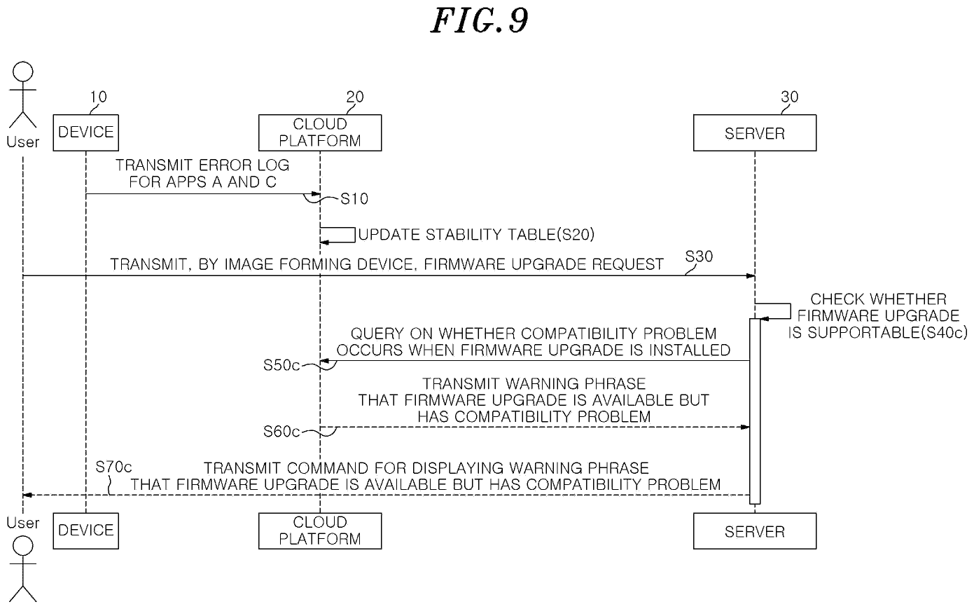

FIG. 8 is a flowchart illustrating a method of upgrading firmware of an image forming device according to an example, and FIG. 9 is a schematic diagram for describing an operation based on firmware of an image forming device being upgraded according to an example. In the example illustrated in FIGS. 8 and 9, operations S10 to S30 are the same as those described above with reference to FIGS. 2 and 3, and thus descriptions thereof will not be repeated.

The example described in FIGS. 8 and 9 relates to displaying warning text stating that an incompatibility with the application in the image forming device may occur based on upgrading the firmware to the latest version on the user interface of the image forming device.

Referring to FIGS. 8 and 9, based on the server 30 receiving a firmware upgrade request from the image forming device 10 in operation S30, the server 30 may check whether a firmware upgrade to the latest version is supportable for the corresponding image forming device 10 in operation S40c.

Based on it being confirmed that the firmware upgrade to the latest version is supportable for the image forming device 10 in the server 30, the server 30 may query the cloud platform 20 as to whether an incompatibility with the applications previously installed in the image forming device 10 occurs based on the latest version of the firmware upgrade being installed in the image forming device 10 in operation S50c.

In response to the query, the cloud platform 20 detects whether the correspondence between the platform version (e.g., platform version 3.1) associated with the firmware (e.g., firmware version 25.1) of the latest version and the application installed in the image forming device 10 is “Stable” in view of the information about the compatibility of the platform version and the application version which are included in the stability table 500. In an example, based on it being detected that the correspondence between the platform version associated with the latest version of the firmware and the application installed in the image forming device 10 is not “Stable,” that is, based on it being detected that there is an application that does not operate stably with the latest version of the firmware, the cloud platform 20 may transmit a notification including a warning that an incompatibility with some applications may occur based on performing such an upgrade, together with the latest version of the firmware to be upgraded, to the server 30 in operation S60c.

For example, referring again to FIG. 1, in the second image forming device 10b, the firmware version 24.1, the platform version 2.1, the version v2 of application A, the version v2 of application B, and the version v2 of application C may be currently installed. However, according to the stability table of FIG. 4, since the version v2 of application A corresponding to the platform version 3.1 associated with the latest version 25.1 of firmware is marked as “Unstable,” based on performing a firmware upgrade to version 25.1, which is the latest version, the cloud platform 20 may transmit to the server 30 a notification including a warning that although the upgrade from the firmware version 24.1 to the firmware version 25.1 may proceed, there may be an incompatibility with some applications (i.e., application A) during such firmware upgrade. In an example, the cloud platform 20 may transmit to the server 30 a notification that the firmware upgrade is allowed based on deleting or deactivating the application in the image forming device 10 that is not compatible with the platform of the latest version of firmware.

Based on the server 30 receiving a notification including a warning that the firmware upgrade is available but may cause the incompatibility with some applications or receiving a notification that the firmware upgrade is allowed based on deleting or deactivating the application in the image forming device 10 that is not compatible with the platform of the latest version of the firmware from the cloud platform 20, the server 30 may transmit a command for displaying content including the above information on the user interface of the image forming device 10 in operation S70c. Based on receiving such a command from the server 30, for example, in a pop-up window of the user interface of the image forming device 10, an item for selecting the firmware upgrade may be activated and displayed, and a warning phrase such as “error may occur” or “incompatibility with some applications may occur” may also be displayed in the “Status” item of the pop-up window. Alternatively, in the pop-up window of the user interface of the image forming device 10, the item for selecting the firmware upgrade may be deactivated and displayed, and a phrase such as “firmware upgrade is allowed based on deleting or deactivating application A” may also be displayed. An implementation example of the user interface of the image forming device 10 is not limited.

Based on the user selecting to proceed with the firmware upgrade or continuing to upgrade the firmware after deleting or deactivating the application informed as having an incompatibility, the upgrade to the latest version of the firmware of the image forming device 10 is performed by the server 30.

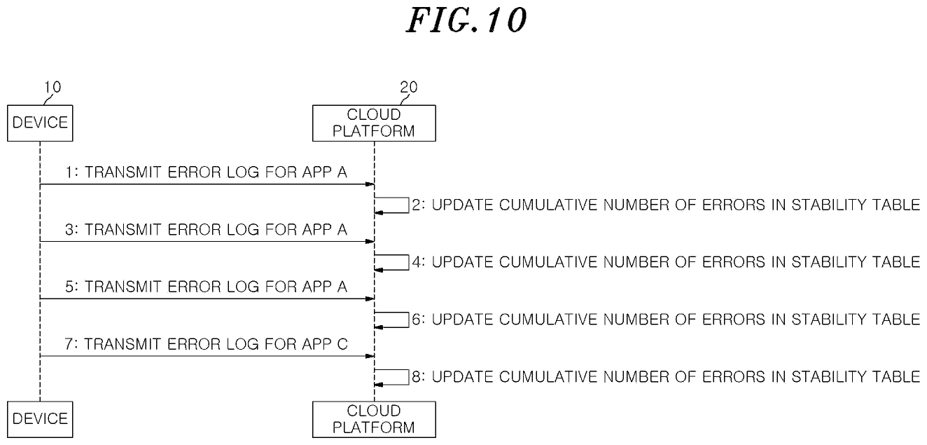

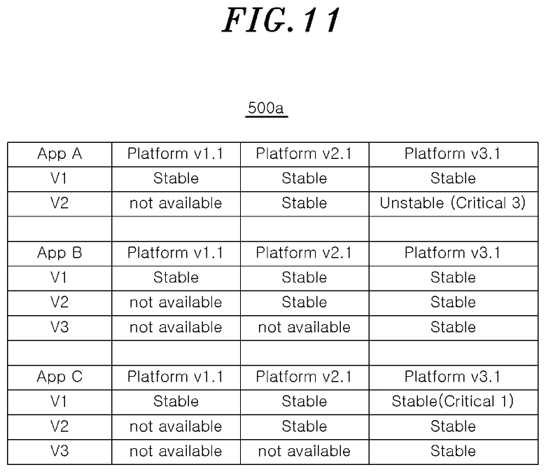

FIG. 10 is a diagram for describing a method of updating a stability table according to an example, and FIG. 11 illustrates a stability table according to an example. FIGS. 10 and 11 illustrate a method of considering the cumulative number of occurrences of errors based on the stability table being updated.

As described above with reference to FIGS. 1 and 2, based on errors occurring while the applications currently installed are executed, the image forming device 10 may generate the error log for the errors and transmit the generated error log to the cloud platform 20. The cloud platform 20 may update the stability table on the basis of the error log received from the image forming device 10. In this case, as illustrated in FIGS. 10 and 11, based on the cloud platform 20 receiving the errors from the image forming device 10 and updating the stability table 500a, the cloud platform 20 accumulates and records the number of errors that occurred in the correspondence between the application version and the platform version in which the error occurred (e.g., based on receiving a single error, it is recorded as “Stable (Critical 1)” and, based on receiving a total of two errors, it is recorded as “Stable (Critical 2)”), and based on the number of accumulated errors being greater than or equal to a predetermined threshold (e.g., three), the cloud platform 20 may change the correspondence between the application version and the platform version in the stability table 500a to “Unstable (Critical 3).” Accordingly, it is possible to prevent a case in which the firmware upgrade for the image forming device is blocked due to a one-time error that has occurred by chance, and thus, a reasonable firmware upgrade method may be provided.

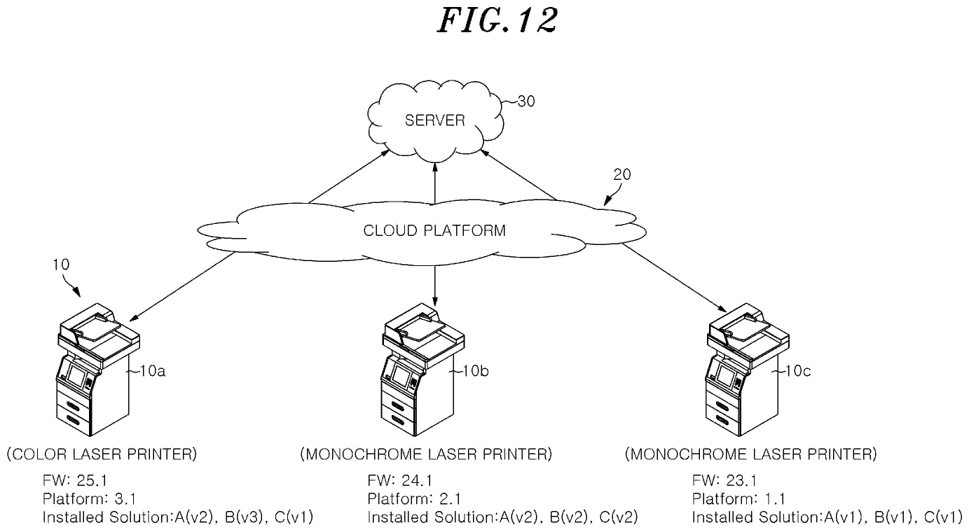

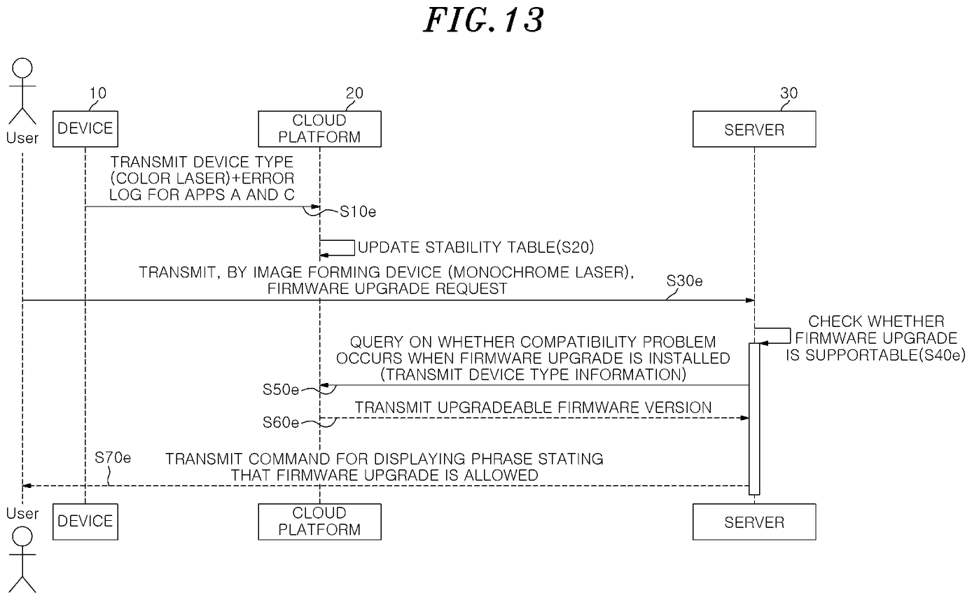

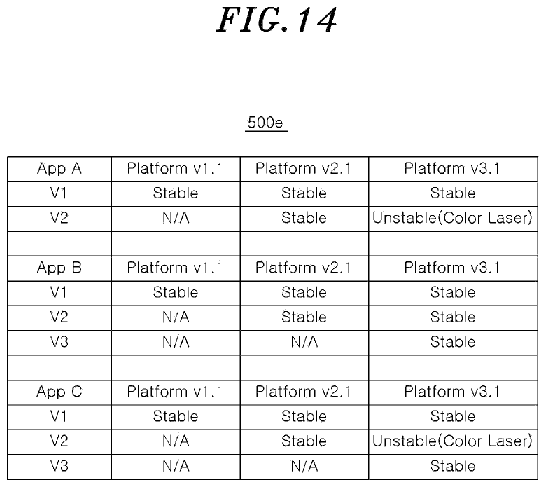

FIG. 12 is a diagram illustrating a system including a server, a cloud platform, and a plurality of image forming devices according to an example. FIG. 13 is a schematic diagram for describing an operation based on firmware of an image forming device being upgraded according to an example, and FIG. 14 illustrates a stability table according to an example.

A method of upgrading firmware according to FIGS. 12 to 14 relates to a case in which a device type of the image forming device is also considered in a situation in which the firmware is upgraded. Here, the device type of the image forming device may be classified into a printer, a scanner, a fax machine, an MFP, a display device, and the like. Further, the device type of the image forming device may also be classified according to whether monochrome printing and/or display is supported or color printing and/or display is supported. Further, the device type of the image forming device may be classified into a 2D image forming device or a 3D image forming device. That is, the classification of the device type of the image forming device may vary depending on the design of the method of upgrading the firmware, but the example is not limited thereto.

Referring to FIG. 12, the image forming devices 10 may include a plurality of image forming devices 10a, 10b, and 10c. In this case, a first image forming device 10a may be a color laser printer, and a second image forming device 10b and a third image forming device 10c may be monochrome laser printers. In this example, the first image forming device 10a, which is a color laser printer, has firmware version 25.1 installed, and a version v2 of application A and a version v2 of application C, which are installed, may cause an error in firmware version 25.1.

In this case, as illustrated in operation S10e of FIG. 13, based on transmitting an error log to the cloud platform 20, information about a device type of the first image forming device 10a being a color laser printer may also be transmitted together with information about the version v2 of application A and the version v2 of application C causing an error in the firmware version 25.1. In addition, as shown in a stability table 500e of FIG. 14, based on the stability table 500e being updated in operation S20, the device type may also be updated (e.g., “Unstable (Color Laser)”) in a correspondence between the application version and the platform version in which the errors have occurred.

Hereinafter, it is assumed that a firmware upgrade is requested in the second image forming device 10b, which device type is a monochrome laser printer and in which firmware version 24.1, a version v2 of application A, and a version v2 of application C are installed in operation S30e of FIG. 13. Based on the server 30 receiving the firmware upgrade request from the second image forming device 10b in operation S30e, the server 30 may check whether a firmware upgrade to the latest version is supportable for the corresponding second image forming device 10b in operation S40e. Based on confirmation that the firmware upgrade to the latest version is supportable for the second image forming device 10b in the server 30, the server 30 may query the cloud platform 20 as to whether incompatibility with the applications previously installed in the second image forming device 10b occurs based on the latest version of the firmware upgrade being installed in the second image forming device 10b in operation S50e. The query of operation S50e may include the device type information of the second image forming device 10b (i.e., monochrome laser printer). In this case, the cloud platform 20 may detect that, on platform version 3.1 associated with firmware version 25.1, which is the latest version, the case in which the version v2 of application A and the version v2 of application C are unstable corresponds to the case in which the device type is a color laser printer, and in the case in which the device type of the image forming device is a monochrome laser printer, there is no incompatibility with the version v2 of application A and the version v2 of application C even in a situation in which the firmware is upgraded to the latest version 25.1 in view of the stability table 500e. As a result of the detection, the cloud platform 20 may transmit an upgradable firmware version to the server 30 in operation S60e of FIG. 13. Accordingly, the server 30 may transmit a command for displaying a phrase stating that the firmware upgrade is allowed on a user interface of the second image forming device 10b to the second image forming device 10b in operation S70e of FIG. 13.

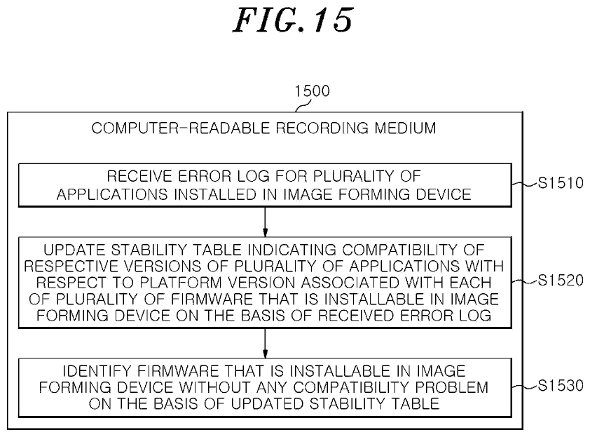

FIG. 15 is a diagram illustrating instructions stored in a non-transitory computer-readable recording medium according to an example.

Each of the instructions stored in the above-described non-transitory computer-readable recording medium may be implemented through a computer program which is programmed to perform each corresponding operation, and such a computer program may be stored in the non-transitory computer-readable recording medium and executable by a processor. In FIG. 15, examples of operations of a computer program which are performed on a non-transitory computer-readable recording medium 1500 are illustrated.

Referring to FIG. 15, instructions S1510 to receive an error log for a plurality of applications installed in an image forming device may be included in the non-transitory computer-readable recording medium 1500.

Further, instructions S1520 to update a stability table indicating compatibility of respective versions of the plurality of applications with respect to a platform version associated with each of a plurality of firmware that is installable in the image forming device on the basis of the received error log may be included in the non-transitory computer-readable recording medium 1500.

Further, instructions S1530 to identify firmware that is installable in the image forming device without any incompatibility on the basis of the updated stability table may be included in the non-transitory computer-readable recording medium 1500.

In an example, each of the operations described above with reference to FIGS. 2, 3, 6 to 10, and 13, including the instructions s1510, s1520, and S1530, may be performed by a computer including a processor according to the execution of the computer program stored in the non-transitory computer-readable recording medium 1500. Accordingly, parts not described below will refer to the parts described above related to the method of upgrading the firmware for the image forming device.

The non-transitory computer-readable medium refers to a medium for storing data semi-permanently rather than a medium for storing data for a short moment, such as a register, a cache, a memory, and the like, and may be read by a device. For example, the instructions for performing the above-described various methods may be stored and provided in a non-transitory readable medium such as a compact disc (CD), a digital video disc (DVD), a hard disk, a Blu-ray disc, a Universal Serial Bus (USB), a memory card, a read only memory (ROM), and the like.

The methods according to various examples described above may be included and provided in a computer program product. The computer program product may be traded between a seller and a buyer as a commodity. The computer program product may be distributed in the form of a machine-readable storage medium (e.g., compact disc read only memory (CD-ROM)) or may be distributed online through an application store (e.g., Play Store™). In the case of online distribution, at least some computer program products may be temporarily stored or temporarily generated in a storage medium such as a memory of a server of a manufacturer, a server of an application store, or a relay server.

While examples have been described with reference to the drawings, various modifications and alterations may be made from the above description. For example, based on the described technologies being performed in orders different from the described examples, and/or the described components such as a system, a structure, a device, and a circuit are coupled or combined in a form different from the described examples, or replaced or substituted with other components or equivalents, the appropriate result may be achieved.

Although examples have been described in the context of the image forming device, the examples are not limited to the image forming device. It may be understood that the spirit of the described examples may be applied to other types of devices or systems to which a firmware upgrade is applicable.

Therefore, the scope of the examples is defined not by the described examples but by the appended claims, and encompasses equivalents that fall within the scope of the appended claims.

What is claimed is:

1. A remote management server comprising:
a processor; and
a memory to store instructions, wherein execution of the instructions cause the processor to:
receive an error log for an application installed in an image forming device;
update, based on the received error log, stability information indicating compatibility between each version of the application and each platform version associated with a plurality of firmware installable in the image forming device; and
identify a firmware to be installed in the image forming device based on the updated stability information.

2. The remote management server of claim 1, wherein the error log includes errors that occur based on the application running on a platform associated with the firmware installed in the image forming device.

3. The remote management server of claim 1, wherein execution of the instructions further cause the processor to:
transmit a command for displaying, on a user interface of the image forming device, an indication that a firmware upgrade is not allowed in a case in which, as a result of the identification of the firmware that is installable in the image forming device without any incompatibility based on the updated stability information, it is detected that there is no compatibility between a platform of a latest version of the firmware and the application of the image forming device if the latest version of the firmware is installed in the image forming device.

4. The remote management server of claim 1, wherein execution of the instructions further cause the processor to:
identify a firmware that is installable in the image forming device without any incompatibility based on the updated stability information and select to install a newest version of the firmware among the identified firmware in the image forming device.

5. The remote management server of claim 1, wherein execution of the instructions further cause the processor to:
transmit a command for displaying, on a user interface of the image forming device, a warning that a firmware upgrade is allowed but an incompatibility occurs in a case in which, as a result of the identification of the firmware that is installable in the image forming device without any incompatibility based on the updated stability information, it is detected that there is no compatibility between a platform of a latest version of the firmware and the application of the image forming device if the latest version of firmware is installed in the image forming device.

6. The remote management server of claim 1, wherein execution of the instructions further cause the processor to:
transmit a command for displaying, on a user interface of the image forming device, a notification that a firmware upgrade is allowed after the application of the image forming device which is not compatible with the platform of the latest version of firmware is deleted or deactivated based on, as a result of the identification of the firmware that is installable in the image forming device without any incompatibility based on the updated stability information, detecting that there is no compatibility between a platform of a latest version of the firmware and the application of the image forming device if the latest version of firmware is installed in the image forming device.

7. The remote management server of claim 1, wherein the update of the stability information based on the received error log includes:
accumulating and recording a number of errors that occur between an application version and a platform version and, based on the number of errors that occur between the application version and the platform version being greater than or equal to a predetermined threshold value, detecting that there is no compatibility between the corresponding application version and the corresponding platform version.

8. The remote management server of claim 1, further comprising:
receiving information about a device type of the image forming device with the error log for the application installed in the image forming device; and
updating the stability information based on the received error log and the information about the device type of the image forming device.

9. A method for upgrading firmware, the method comprising:
receiving an error log for an application installed in an image forming device;
updating stability information indicating compatibility between each version of the application and each platform version associated with a plurality of firmware installable in the image forming apparatus based on the received error log; and
identifying a firmware to be installed in the image forming device based on the updated stability information.

10. The method of claim 9, further comprising:
transmitting a command for displaying, on a user interface of the image forming device, an indication that a firmware upgrade is not allowed in a case in which, as a result of the identification of the firmware that is installable in the image forming device without any incompatibility on the basis of the updated stability information, it is detected that there is no compatibility between a platform of a latest version of the firmware and the application of the image forming device based on the latest version of firmware being installed in the image forming device.

11. The method of claim 9, further comprising:
identifying firmware that is installable in the image forming device without any incompatibility based on the updated stability information and selecting to install a newest version of the firmware among the identified firmware in the image forming device.

12. The method of claim 9, further comprising:
transmitting a command for displaying, on a user interface of the image forming device, a warning that a firmware upgrade is allowed but an incompatibility occurs in a case in which, as a result of the identification of the firmware that is installable in the image forming device without any incompatibility on the basis of the updated stability information, it is detected that there is no compatibility between a platform of a latest version of the firmware and the application of the image forming device based on the latest version of firmware being installed in the image forming device.

13. The method of claim 9, wherein the updating of the stability information on the basis of the received error log includes:
accumulating and recording a number of errors that occur between an application version and the platform version; and
based on the number of errors that occur between the application version and the platform version being greater than or equal to a predetermined threshold value, detecting that there is no compatibility between the corresponding application version and the corresponding platform version.

14. The method of claim 9, further comprising:
receiving information about a device type of the image forming device with the error log for the application installed in the image forming device; and
updating the stability information based on the information about the device type of the image forming device.

15. A computer-readable recording medium storing instructions, wherein the instructions, when executed by a processor, cause the processor to perform operations comprising:
receiving an error log for an application installed in an image forming device;
updating stability information indicating compatibility between each version of the application and each platform version associated with a plurality of firmware installable in the image forming device based on the received error log; and
identifying a firmware to be installed in the image forming device based on the updated stability information.
